(19) United States
(12) Patent Application Publication
(10) Pub. No.: US 2009/0284578 A1
(43) Pub. Date: Nov. 19, 2009

(54) REAL ESTATE COMMUNICATIONS AND MONITORING SYSTEMS AND METHODS FOR USE BY REAL ESTATE AGENTS

(75) Inventor: Ronald Carter, Matthews, NC (US)

Correspondence Address: TILLMAN WRIGHT, PLLC, PO BOX 49309, CHARLOTTE, NC, 28277-0076, US

(73) Assignee: REVOLUTIONARY CONCEPTS, INC., Matthews, NC (US)

(21) Appl. No.: 12/464,075

(22) Filed: May 11, 2009

Related U.S. Application Data
(60) Provisional application No. 61/052,242, filed on May 11, 2008.

(51) Int. Cl. H04N 7/14

(52) U.S. Cl. 348/14.02; 348/E07.077

(57) ABSTRACT

Two-way audiovideo communications are provided between a prospect located in a room and a remotely located real estate agent using a wireless handheld device, whereby the remotely located agent may present a space to, and answer questions by, prospects. A method includes: transmitting, to the wireless handheld device used by the agent, audiovideo of the prospect recorded using a camera located in the room; transmitting, to the wireless handheld device used by the agent, audiovideo of the prospect recorded using a microphone located in the room; and transmitting, to a speaker located in the room for playing to the prospect, audio of the agent recorded using the wireless handheld device. The transmitting includes wireless communications between the camera and microphone located in the room, and a computerized controller running a software application including a graphic user interface by which the audiovideo communications between the prospect and the agent are established.

### CROSS-REFERENCE TO RELATED APPLICATION

The present application is a U.S. Nonprovisional Patent Application of, and claims priority under 35 U.S.C. § 119(e) to, U.S. Provisional Patent Application 61/052,242, filed May 11, 2008, which provisional patent application is incorporated by reference herein. The disclosure of this provisional application is contained in Appendix A, attached hereto, forming a part hereof, and incorporated herein by reference. Additionally, the following are hereby incorporated herein by reference: U.S. Patent Application Publications 2007/0188612 and 2007/0103541; and U.S. Pat. No. 7,193,644.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND

Current practice in the real estate process is for a prospective buyer interested in a particular property to meet with a real estate agent representing the buyer for purposes of viewing properties for sale. The buyer's agent shows the prospective buyer a property, typically without the seller's real estate agent being present; however, the seller's agent generally provides a hardcopy description of the property on premises for the benefit of the prospective buyer. The prospective buyer viewing the property shares with the buyer's agent any questions or concerns, and the buyer's agent contacts the seller's agent. Upon hearing back from the seller's agent, the buyer's agent then contacts the prospective buyer. Of course, the prospective buyer must wait for the seller's agent to respond and for the buyer's agent to get back to the prospective buyer. As will be appreciated, a need exists for improved efficiencies in this process. One or more preferred embodiments of the present invention address such need.

### SUMMARY OF THE INVENTION

The present invention includes many aspects and features. Furthermore, while the present invention is described in the context of real estate sales, it will be appreciated that the invention is further applicable in other contexts, including real estate rentals and leases. Moreover, the invention is applicable in both commercial and residential sales and rentals of real estate properties.

A first aspect of the invention relates to a method for two-way audiovideo communications between a prospect located in one of a plurality of rooms in a building and a remotely located real estate agent, whereby real time audiovideo communications between the prospect and the remotely located agent is provided by the agent using a wireless handheld device.

The method includes the steps of: (a) transmitting, to the wireless handheld device used by the agent, video of the prospect recorded using a camera located in the room; (b) transmitting, to the wireless handheld device used by the agent, audio of the prospect recorded using a microphone located in the room; and (c) transmitting, to a speaker located in the room for playing to the prospect, audio of the agent recorded using the wireless handheld device.

In accordance with this aspect, the transmitting steps include wireless communications between the camera and microphone located in the room and a computerized controller running a software application including a graphic user interface by which the audiovideo communications between the prospect and the agent are established.

In a feature of this aspect, the audiovideo communications are streamed.

In a feature of this aspect, the wireless handheld device comprises a cell phone, a video phone, a personal digital assistant, or a smartphone.

In a feature of this aspect, the wireless handheld comprises a programmable handheld device.

In a feature of this aspect, the method further includes the step of saving a recording of the two-way audio-communications in a database for later playback.

In a feature of this aspect, the method further includes transmitting, to a display screen located in the room for presentation to the prospect, video of the agent recorded using the wireless handheld device. Said transmitting steps may include communications over the Internet, communications over a cellular network, communications over a satellite network, or any combinations of the foregoing

In a feature of this aspect, the method further includes remotely actuating the camera located in the room using the wireless handheld device. Said step of remotely actuating the camera may include zooming an image of the prospect, and said step of remotely actuating the camera may include remotely moving the camera to change the view of the camera.

In a feature of this aspect, the software maintains an association of each one of a plurality of peripheral devices with respective agents, any of the peripheral devices capable of being utilized in the system. Furthermore, the software may provide a graphical user interface through which the audiovideo data from the wireless device is accessed by each respective agent using one of the peripheral devices.

In a feature of this aspect, the room is a room of a residence that is for sale or rent, or a room of a commercial space that is for sale or lease.

Another aspect of the invention relates to a communications and monitoring system. The system includes: (a) a wireless device associated with a room and configured to communicate audio and video data; (b) a plurality of peripheral devices, each peripheral device associated with a respective real estate agent; and (c) a computer configured for communication with the wireless device and configured for communication with each of the peripheral devices. In accordance with this aspect, the computer executes software, in accordance with which, (i) the association of each of the peripheral devices with a respective agent is maintained, (ii) audio and video data from the wireless device is received by the computer, and (iii) a graphical user interface is provided through which audio and video data from the wireless device is accessible by each respective agent using one of the peripheral devices. Furthermore, in accordance with this aspect, the room is a room of a commercial or residential space that is for rent or sale.

In a feature of this aspect, the wireless device includes a camera, a microphone, a speaker, an RF transmitter, and an RF receiver.

In a feature of this aspect, the wireless device further communicates with a proximity sensor located in the room for actuation of the wireless device.

In a feature of this aspect, audio and video data received from the wireless device is recorded, and access to the recorded audio and video data is provided through the graphical user interface, all in accordance with the software.

In a feature of this aspect, the audio and video data is recorded to a storage device selected from the group of a CD-ROM R/W, a DVD R/W, a camera card, a tape drive, and a hard drive.

In a feature of this aspect, the computer associates one of various levels of access privileges to each agent, all in accordance with the software.

In a feature of this aspect, the computer facilitates audio communications between a prospect using the wireless device, and a particular one of the agents, by initiating communications with the respective peripheral device associated with that agent, all in accordance with the software.

In a feature of this aspect, the computer is configured for communication, via the Internet, with one or more of the plurality of peripheral devices such that audio and video data from the wireless device is remotely accessible via the Internet by a respective agent using one of the peripheral devices.

In a feature of this aspect, the computer is configured for communication, via a public switching telephone network, with one or more of the plurality of peripheral devices such that audio and video data from the wireless device is remotely accessible via the public switching telephone by a respective agent using one of the peripheral devices.

In a feature of this aspect, the computer is configured for communication, via a local area network, both with the wireless device and with one or more of the plurality of peripheral devices such that audio and video data from the wireless device is accessible via the local area network by a respective agent using one of the peripheral devices.

In a feature of this aspect, the plurality of peripheral devices each comprises a digital communication device.

In a feature of this aspect, at least one of the plurality of peripheral devices comprises a cell phone, telephone, video-cell phone, computer, personal digital assistant, video-personal digital assistant, satellite telephone, or pager.

In a feature of this aspect, the wireless device and at least one of the peripheral devices are configured for communications via text messaging.

In a feature of this aspect, the wireless device is portable, has a locking mechanism, and an electrical receptacle for quickly attaching to a source of electricity, and wherein the wireless device further includes a portable energy source.

In a feature of this aspect, the computer comprises a module for authenticating an agent based on a biometric of the agent.

In a feature of this aspect, the biometric comprises at least one of the group of an agent's face, eye, voice, fingerprint, palmprint, or some other biological information.

In a feature of this aspect, the computer comprises a voice-generation apparatus.

In another aspect of the invention, a communications and monitoring system includes: (a) a wireless device associated with a room and configured to communicate audio and video data; (b) a plurality of peripheral devices, each peripheral device associated with a respective real estate agent; and (c) a computer configured for communication with the wireless device and configured for communication, via the Internet, with each of the peripheral devices. In accordance with this aspect, the computer executes software, in accordance with which, (i) the association of each of the peripheral devices with a respective agent is maintained, (ii) audio and video data from the wireless device is received and stored by the computer, (iii) a graphical user interface is provided through which audio and video data from the wireless device is accessible, via the Internet, by each respective agent using one of the peripheral devices, and (iv) each agent is authenticated based on a biometric of the agent. Furthermore, in accordance with this aspect, the room is a room of a commercial or residential space that is for rent or sale.

In a feature of this aspect, communications provided are real-time communications. In another feature, communications provided are prerecorded. In other features, some communications are real-time and others are prerecorded.

In a feature of this aspect, the wireless device used by the real estate agent for real time communications is a general handheld device configured, inter alia, for use with a system in accordance with this aspect. In another feature, the wireless device used by the real estate agent for real time communications is a dedicated device for use solely with a system in accordance with this aspect.

In addition to the aforementioned aspects and features of the present invention, it should be noted that the present invention further encompasses the various possible combinations and subcombinations of such aspects and features.

### BRIEF DESCRIPTION OF THE DRAWINGS

FIG. 1 illustrates a house that is for sale or lease and that is setup to utilize preferred systems and methods in accordance with the present invention.

FIG. 2 illustrates a system architecture in preferred systems and methods in accordance with the present invention.

FIG. 3 illustrates another system architecture in preferred systems and methods in accordance with the present invention.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

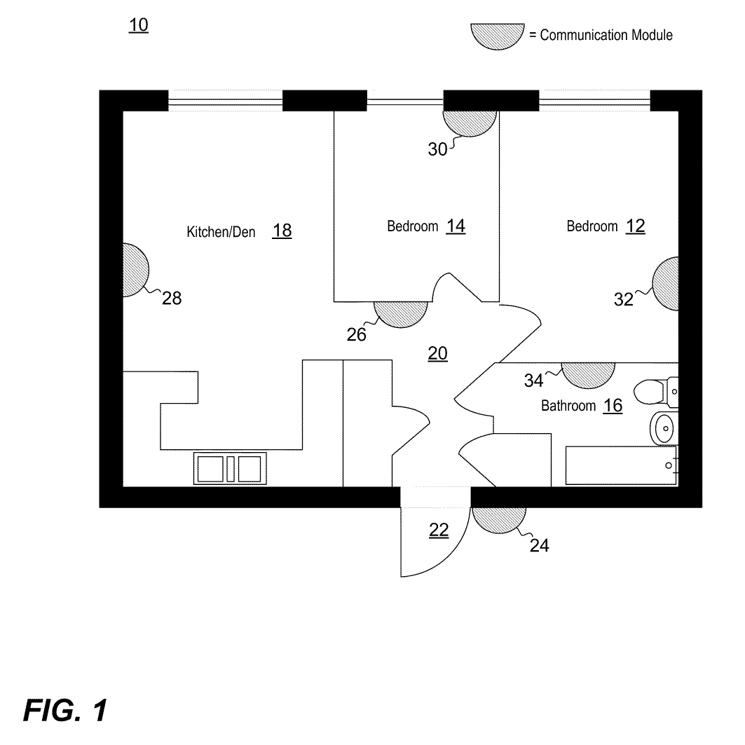

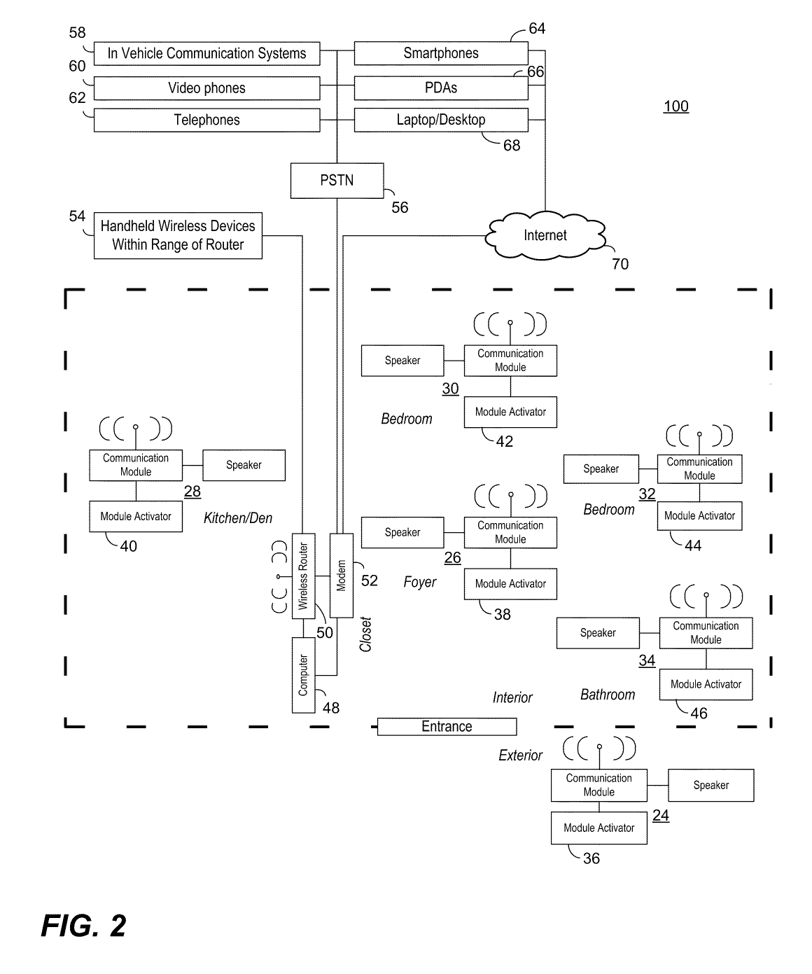

A first, preferred system 100 is now described with reference to FIGS. 1-2.

In this respect, FIG. 1 illustrates a floor plan of a home that is for sale. The home includes a first bedroom 12 and second bedroom 14, one bathroom 16, as well as an open area 18 comprising the kitchen and den and a foyer 20 having two closets. In accordance with the present invention, communication modules are located in the rooms of the home and at an exterior of an entrance 22 to the home. Specifically, these communication modules include: communication module 24 at the exterior of the entrance 22 to the home; communication module 26 in the foyer 20; communication module 28 in the open area 18; communication module 30 in the first bedroom 12; communication module 32 in the second bedroom 14; and communication module 34 in the bathroom 16. Each communication module preferably is mounted to a wall of the home, and the communication modules are placed throughout the home in positions that provide effective communication with a prospective buyer in showing the property.

Each communication module further may be portable and may be removably attached to a mounting that is secured to a wall. In this respect, the communication module or the mounting may further include a locking mechanism for securing the communication module when retained by the mounting. Each communication module also may be powered by electrical receptacle, may include a portable energy source such as a batter (especially if portable), or may include both.

FIG. 2 illustrates components of the system 100 including the communication modules arranged in the home represented by the floor plan of FIG. 1. The components shown include hardware and software components, and it will be appreciated that any hardware component of the system 100 is subject to possible replacement with a software component, and vice-versa, as desired and if within the skill of the Ordinary Artisan. Moreover, it is noted that software components have the added advantage over hardware components of being updated periodically with enhancements, and may even be reconfigured as necessary. Indeed, a software-driven system may be updated, modified, and customized for providing robust applications.

The components of the system 100 include: communication modules 24,26,28,30,32,34; module activators 36,38,40,42,44,46; a desktop or laptop computer 48 including software and data storage for implementing the invention; a wireless router 50; a modem 52; a plurality of handheld devices 54 configured for wireless communication with the wireless router 50; a plurality of telecommunication devices for communication over a public switched telephone network 56 directly with the computer 48 via the modem 52 (e.g., a telephone-line modem), such telecommunication devices including in-vehicle communication systems 58, video phones 60, telephones 62, smartphones 64, PDA devices 66 having telecommunication capabilities, and laptop and desktop computers 68 having telecommunication capabilities; and a plurality of devices for communications over the Internet 70 with the computer 48 via the modem 52 (e.g., DSL or cable modem), such devices including smartphones 72 that are web-enabled, PDA devices 74 that are web-enabled, and laptop and desktop computers 76 that are web-enabled. Optionally, the wireless router 50 may be replaced with, or function as, a wireless access point, with the computer 48 providing functions that would otherwise be provided by the wireless router 50.

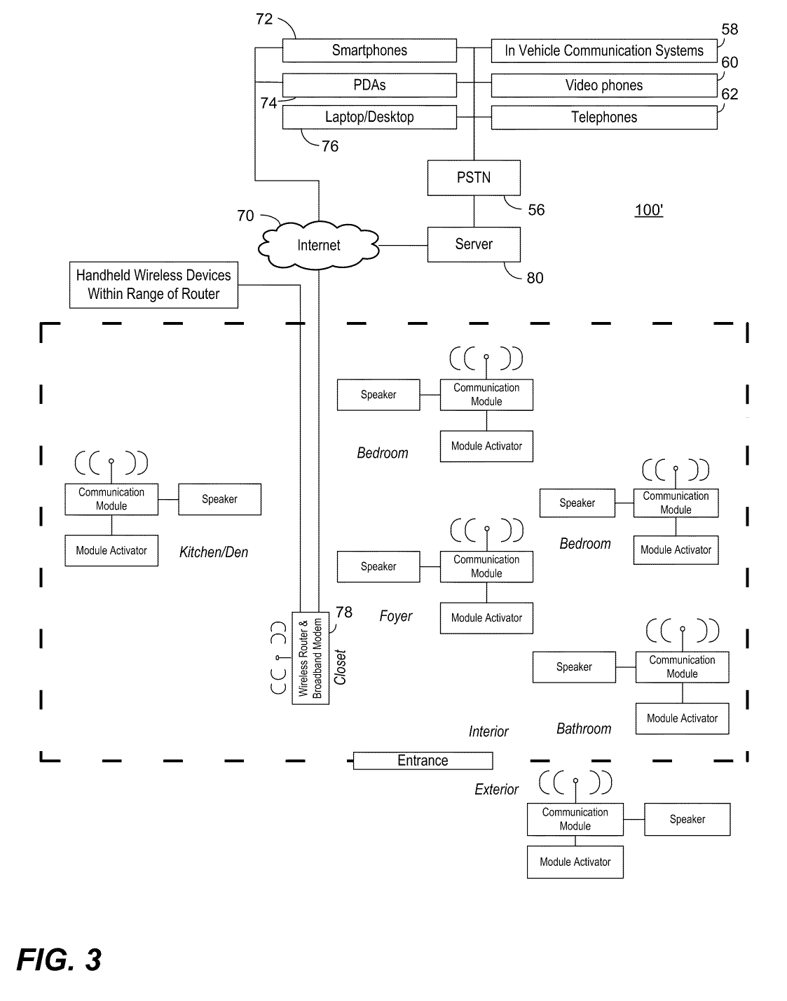

Each of the communication modules preferably includes a video camera, a microphone, a speaker, a display screen such as an LCD screen, an RF transmitter, and an RF receiver. The RF transmitter and RF receiver may be combined in the form of a radio component. The communications enabled by each communication module preferably include both audio and visual communications, although communications by only audio or video also is contemplated and enabled in the system 100. Furthermore, the speaker of each communication module is shown as a separate, physical component connected to a respective communication module in FIGS. 2-3; however, it will be appreciated that the speaker component (or any other components) may be separately provided or may be integral with the respective communication module and not separate therefrom, as desired.

Each communication module further includes a module activator that allows a person to manually activate the communication module. The module activator also may be integral with the communication module or may be a separate device located apart from the communication module, as shown in FIGS. 2-3, but nonetheless the module activator is arranged in electronic communication with the communication module whereby the module activator may activate the communication module. Such electronic communication may be wired or wireless.

Each communication module also may include a proximity sensor configured to detect movement Furthermore, upon the detection of movement by the proximity sensor, the video camera of the communication module may be configured to record images, and the microphone may be configured to record audio. Additionally, or alternatively, upon the detection of movement by the proximity sensor, the communication module may be configured to output a preprogrammed message or to initiate a call to a seller's agent for two-way real time communication with a seller's agent utilizing a handheld wireless device.

Moreover, each communication module works independently of the others and, when taken collectively, the communication modules provide comprehensive surveillance and coverage of a property.

Each of the handheld wireless devices preferably comprises a general handheld wireless device or a dedicated handheld wireless device that includes a camera, a microphone, a speaker, a display screen such as an LCD screen, an RF transmitter, and an RF receiver. The RF transmitter and RF receiver may be combined in the form of a radio component.

In either event, these devices sometimes are referred to herein as peripheral devices, and a peripheral device may be a cell phone, a video phone, a personal digital assistant (PDA), or a smartphone of the agent that has general applicability outside of the present invention. Alternatively, the peripheral device may be a dedicated device designed and configured solely for use with the system 100. In either scenario, the handheld wireless device preferably is a programmable device for which software may be written and executed on the device, and preferably is a digital communication device.

In an alternative system 100′ shown in FIG. 3, the computer 48, wireless router 50 and modem 52 are replaced by a device 78 that includes both the wireless router and modem functionality, and a computer in the form of server 80 remotely located from the property is configured for Internet communications and communicates with the combination device 78. Furthermore, the server 80 communicates with a plurality of devices over the Internet 70 including smartphones 72 that are web-enabled, PDA devices 74 that are web-enabled, and laptop and desktop computers 76 that are web-enabled; and the server 80 communicates directly with a plurality of telecommunication devices over the public switched telephone network 56 including in-vehicle communication systems 58, video phones 60, telephones 62, smartphones 64, PDA devices 66 having telecommunication capabilities, and laptop and desktop computers 68 having telecommunication capabilities. In this case, the arrangement of components in system 100′ otherwise is the same as that in system 100 of FIG. 2.

As represented in each of FIGS. 2 and 3, the computer is configured for communication, via the Internet, with one or more of the plurality of peripheral devices such that audio and video data from the communication module (also referred to herein as a wireless device) is remotely accessible via the Internet by a respective agent using one of the peripheral devices; the computer is configured for communication, via a public switching telephone network, with one or more of the plurality of peripheral devices such that audio and video data from the wireless device is remotely accessible via the public switching telephone by a respective agent using one of the peripheral devices; and the computer is configured for communication, via a local area network, both with the wireless device and with one or more of the plurality of peripheral devices such that audio and video data from the wireless device is accessible via the local area network by a respective agent using one of the peripheral devices.

The communication modules also are configured to communicate directly with peripheral devices when peripheral devices are within communication range of the wireless router 50. In this respect, communications over the Internet 70 or PSTN 56 are unnecessary in the arrangement of FIG. 2, as each of the peripheral devices in transmission range of the wireless router 50 may communicate directly through the wireless router with the computer 48 in gaining access to a particular communication module. When such devices leave the communication range of the wireless router 50, communications then preferably are achieved in the system 100 over the Internet 70 or PSTN 56. In contrast, in the arrangement of FIG. 3, communications nonetheless continue to occur over the Internet 70 even when peripheral devices are within the communication range of the wireless router 50, because the computer 80 is remotely located relative to the property.

Utilizing these components, real time, two-way audiovideo communications between a prospect located in one of the rooms of the home and a seller's agent remotely located to the home are accomplished.

In particular, video of the prospect recorded using a camera of the communication module located in the room is transmitted to the wireless handheld device used by the agent; audio of the prospect recorded using a microphone of the communication module located in the room is transmitted to the wireless handheld device used by the agent. The transmitted audiovideo content is played on the handheld device used by the agent. Similarly, audio of the agent recorded using the wireless handheld device is transmitted to and played on a speaker of the communication module located in the room for presentation to the prospect; and video of the agent recorded using the wireless handheld device is transmitted to and displayed on a screen of the communication module located in the room for presentation to the prospect. The transmissions, displaying and playing of the audiovisual content preferably is in real time, whereby the prospect and agent are able to naturally converse. Optionally, the communication module and at least one of the peripheral devices are configured for communications via text messaging.

In order to initiate such conversation, activation of a communication module may be accomplished manually, for example, by a person pushing a button or otherwise actuating a physical input of the module activator with the intent of making a call to the seller's agent. This may be preferred when a prospective buyer is viewing a property with the buyer's agent. Alternatively, actuating a physical input of the module activator, thereby activating a communication module, first may result in the presentation of prerecorded content regarding the property and, in particular, regarding the area or room in which the activated communication module is located. Pushing the button again while the preprogrammed information is presented then may result in a call being initiated to the seller's agent (which may include the agent on duty for the property). Alternatively, more than one physical input of the activator module may be provided, whereby selection of the appropriate input results in the playing of the informational content or the call being initiated to the seller's agent, as desired.

A seller's agent also may activate a communication module remotely, by way of the module activator, by sending an appropriate command to the module activator using the agent's peripheral device. A seller's agent may remotely activate a communication module in order to gain real time inspection of the area or room in which the communication module is located, including zooming in on an image of the prospect and moving the camera to change the field of view of the area or room in which the communication module is located.

A communication module also may be automatically activated by a sensor of the communication module. Such sensor may be configured to activate the communication module upon detection of a predetermined condition or event. For example, each interior communication module may include a proximity sensor and may be automatically activated by the proximity sensor upon detection of a person near the communication module. Upon such activation, the communication module may be configured to automatically present the preprogrammed informational content about the area or room in which the communication module is located. In another example, the exterior communication module 24 preferably includes a proximity sensor that detects movement by someone approaching the entrance of the home, whereupon the respective communication module is activated and automatically presents preprogrammed information about the property. The exterior communication module 24 further may be configured to initiate a call to the seller's agent upon manual actuation of an input of the exterior activator module, whereby the person at the entrance may converse with the seller's agent. Alternatively, the exterior communication module 24 may be configured to automatically initiate a call to the seller's agent upon a person's approach.

It furthermore is contemplated that the exterior communication module 24 may electronically control a locking mechanism of the door at the entrance to the home, and that the exterior communication module 24 may be configured to unlock the door remotely in response to a communication received by the exterior communication module 24 from the seller's agent.

The handheld wireless device, also sometimes referred to herein as peripheral devices, each preferably is associated with a respective real estate agent representing the setter. The computer preferably is configured for communication with each of the peripheral devices. Specifically, the computer preferably executes software, in accordance with which the association of each of the peripheral devices with a respective agent is maintained; audio and video data from each communication module is received by the computer; and a graphical user interface is provided through which audio and video data from each communication module is made accessible to each respective agent using one of the peripheral devices. Each user (or agent in this context) preferably has a level of privileges that define the interactions available to such user with the computer. For example, some users preferably are administrators and have access to configuration, setup and maintenance settings, whereas some users preferably are merely participants and only have the ability to access audiovisual content recorded by the computer or transmitted by a communication module for presentation, as well as the ability to converse with a prospective buyer at a communication module.

Preferably, audio and video data transmitted by each communication module is received and recorded by the computer in a database for searching and later possible playback. The audio and video data may be recorded to a storage device selected from the group of a CD-ROM R/W, a DVD R/W, flash memory, a tape drive, and a hard drive. Access by each peripheral device to the recorded audio and video data then preferably is provided through the graphical user interface. Such access may include a handoff of communications directly between the peripheral device and a particular communication module (in which case, communications also preferably are copied to the computer for recording and archiving), or may include continued use of the computer and GUI as an intermediate agent, wherein the audiovisual content communicated between the peripheral device and the communication module is transmitted by way of the computer. This latter design is believed to be preferred where the peripheral device has limited memory or processing power, and where such peripheral device is better suited to function as a thin client, wherein the processing and memory capacity of the computer are relied upon.

Security in the system is considered important. As such, the computer preferably includes an authentication module by which users of the system are authenticated. Such authentication may include password or token authentication, biometric authentication, or both. If biometric authentication is included, then each user (i.e., agent) preferably provides biometric data that is stored by the computer for later authentication of such user. The biometric may be the agent's face, eye, voice, fingerprint, palmprint, or some other biological information, or any combination of the foregoing.

The computer also preferably includes voice-generation capabilities, whereby interactive-voice-recognition features (IVR)—such as those commonly found in customer service call centers—may be provided in the system.

In essence, the computer preferably serves as the gateway by which each of the peripheral devices gains access to audiovisual content transmitted by any of the communication modules. The computer also preferably serves as a repository for audiovisual content captured or presented by each of the communication modules, and serves as a historical archive of all of the audiovideo communications that have occurred at each communication module. Furthermore, in the arrangement of FIG. 3, the computer may service a plurality of properties, whereby a many-to-one relationship is established between the computer and the properties serviced by such computer. Still, even in this arrangement, the computer serves as the gateway by which peripheral devices gain access to audiovisual content transmitted by any of the communication modules at each of the properties, the computer serves as a repository for all of the audiovisual content captured or presented by each of the communication modules at each such property, and the computer serves as a historical archive of all of the audiovideo communications that have occurred at each communication module at each such property.

As will be appreciated by the Ordinary Artisan, one or more preferred embodiments of the invention provide real time communications between a buyer's agent while showing a property and a seller's agent who is absent from the property. Thus, the seller's agent is accessible for answering questions and for presenting the property while the property is viewed without the necessity of the seller's agent physically being on premises.

As also will be appreciated, one or more preferred embodiments of the invention provide monitoring of a property for sale or rent by a real estate agent with the real estate agent using a wireless handheld device, whereby the real estate agent may be physically absent from the property.

Furthermore, one or more preferred embodiments of the invention provide real time communications between a person interested in renting or leasing a particular property and a landlord's agent while showing a property, even when the landlord's agent is not physically present at the property.

As will also be appreciated, one or more preferred embodiments includes a system that is software driven and is capable of issuing programmed announcements and messages to visitors. Moreover, it will be appreciated that, when activated, the system will capture video of the person, deliver a programmed announcement, and/or notify an agent on duty of the detection of the person in real time, allowing the agent on duty to be available to answer questions from a remote location and enabling the agent on duty to monitor and survey the property remotely.

One or more preferred embodiments also includes a system that effectively provides a virtual tour guide by placing a communication module of the system in a number of rooms or pre-selected areas, which can be configured to describe the property via programmable announcements as well as capture interested customer reactions and provide real time communications with the seller's agent. Thus, the system allows an agent at a remote location to function as a virtual guide in providing a tour of the property to a prospective buyer. This provides increased flexibility both to the prospective buyer and to the agent.

It will furthermore be appreciated that once a sale is consummated and the property is transferred to a new owner, any existing communication modules then can be integrated into a security and surveillance system of the new owner. Moreover, any existing communication modules then can be integrated into a DVMS system, which is disclosed in detail in incorporated U.S. Pat. No. 7,193,644. In this respect, it is contemplated that, for example, the exterior communication module 24 of FIGS. 1-3 may be configured to function as an exterior DVMS module in accordance with such disclosure, and each of the interior communication modules 26,28,30,32,34 of FIGS. 1-3 may be configured to function as interior DVMS transceivers in accordance with such disclosure.

It further will be appreciated that the communication modules and other components of the system 100 may be provided by a property developer when constructing a building, whereby vendors and subcontractors can be received and monitored while on premises. Moreover, the system 100 may be used as a security and surveillance system for the property, prior to marketing of the property. The system then can be turned over to an agent for use in marketing, and then finally turned over to a new owner as part of the new owner's security system or DVMS system.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

For instance, whereas telecommunication and Internet communications have been identified herein, it should also be understood that satellite communications similarly may be utilized in accordance with any of the aspects or features of the invention.

What is claimed is:

1. A method for two-way audiovideo communications between a prospect located in one of a plurality of rooms in a building and a remotely located real estate agent, whereby real time audiovideo communications between the prospect and the remotely located agent is provided by the agent using a wireless handheld device, the method comprising the steps of:
(a) transmitting, to the wireless handheld device used by the agent, video of the prospect recorded using a camera located in the room;
(b) transmitting, to the wireless handheld device used by the agent, audio of the prospect recorded using a microphone located in the room; and
(c) transmitting, to a speaker located in the room for playing to the prospect, audio of the agent recorded using the wireless handheld device;
(d) wherein said transmitting steps include wireless communications between the camera and microphone located in the room and a computerized controller running a software application including a graphic user interface by which the audiovideo communications between the prospect and the agent are established.

2. The method of claim 1, wherein the wireless handheld device comprises a cell phone, a video phone, a personal digital assistant, a smartphone, or a digital communication device.

3. The method of claim 1, further comprising the step of saving a recording of the two-way audio-communications in a database for later playback.

4. The method of claim 1, further comprising transmitting, to a display screen located in the room for presentation to the prospect, video of the agent recorded using the wireless handheld device.

5. The method of claim 1, further comprising remotely actuating the camera located in the room using the wireless handheld device.

6. The system of claim 1, wherein the software maintains an association of each one of a plurality of peripheral devices with respective agents, any of the peripheral devices capable of being utilized in the system.

7. The system of claim 6, wherein the software provides a graphical user interface through which the audiovideo data from the wireless device is accessed by each respective agent using one of the peripheral devices.

8. The system of claim 1, wherein the room is a room of a residence that is for sale or rent, or a room of a commercial space that is for sale or lease.

9. A communications and monitoring system, comprising:
(a) a wireless device associated with a room and configured to communicate audio and video data;
(b) a plurality of peripheral devices, each peripheral device associated with a respective real estate agent; and
(c) a computer configured for communication with the wireless device and configured for communication with each of the peripheral devices;
(d) wherein the computer executes software, in accordance with which,
(i) the association of each of the peripheral devices with a respective agent is maintained,
(ii) audio and video data from the wireless device is received by the computer, and
(iii) a graphical user interface is provided through which audio and video data from the wireless device is accessible by each respective agent using one of the peripheral devices; and
(e) wherein the room is a room of a commercial or residential space that is for rent or sale.

10. The system of claim 9, wherein the wireless device includes a camera, a microphone, a speaker, an RF transmitter, and an RF receiver.

11. The system of claim 9, wherein the wireless device further communicates with a proximity sensor located in the room for actuation of the wireless device.

12. The system of claim 9, wherein, in accordance with the software, audio and video data received from the wireless device is recorded, and access to the recorded audio and video data is provided through the graphical user interface.

13. The system of claim 9, wherein, in accordance with the software, the computer facilitates audio communications between a prospect using the wireless device, and a particular one of the agents, by initiating communications with the respective peripheral device associated with that agent.

14. The system of claim 9, wherein the computer is configured for communication, via the Internet, with one or more of the plurality of peripheral devices such that audio and video data from the wireless device is remotely accessible via the Internet by a respective agent using one of the peripheral devices.

15. The system of claim 9, wherein the computer is configured for communication, via a public switching telephone network, with one or more of the plurality of peripheral devices such that audio and video data from the wireless device is remotely accessible via the public switching telephone by a respective agent using one of the peripheral devices.

16. The system of claim 9, wherein the computer is configured for communication, via a local area network, both with the wireless device and with one or more of the plurality of peripheral devices such that audio and video data from the wireless device is accessible via the local area network by a respective agent using one of the peripheral devices.

17. The system of claim 9, wherein the wireless device and at least one of the peripheral devices are configured for communications via text messaging.

18. The system of claim 9, wherein the computer comprises a module for authenticating a user based on a biometric of the agent.

19. The system of claim 9, wherein the biometric comprises at least one of the group of an agent's face, eye, voice, fingerprint, palmprint, or some other biological information.

20. A communications and monitoring system, comprising:
(a) a wireless device associated with a room and configured to communicate audio and video data;
(b) a plurality of peripheral devices, each peripheral device associated with a respective real estate agent; and
(c) a computer configured for communication with the wireless device and configured for communication, via the Internet, with each of the peripheral devices;
(d) wherein the computer executes software, in accordance with which,
(i) the association of each of the peripheral devices with a respective agent is maintained,
(ii) audio and video data from the wireless device is received and stored by the computer,
(iii) a graphical user interface is provided through which audio and video data from the wireless device is accessible, via the Internet, by each respective agent using one of the peripheral devices, and
(iv) each agent is authenticated based on a biometric of the agent; and
(e) wherein the room is a room of a commercial or residential space that is for rent or sale.
